(19) United States
(12) Patent Application Publication
(10) Pub. No.: US 2013/0087292 A1
(43) Pub. Date: Apr. 11, 2013

(54) Welding Curtian

(71) Applicant: Don Gould, Sheridan, WY (US)

(72) Inventor: Don Gould, Sheridan, WY (US)

(21) Appl. No.: 13/253,782

(22) Filed: Oct. 5, 2011

(51) Int. Cl. B23K 37/00; B23P 11/00

(52) U.S. Cl. 160/89; 29/428; 160/330; 160/237

(57) ABSTRACT

A welding curtain comprises a substrate comprising a fire-resistant material and a number of magnets coupled to a portion of the substrate. A welding curtain comprises a substrate, a number of sliding mechanisms attached to at least a portion of an edge of the substrate, a track defining a groove within a front surface and comprising a back surface, and a number of magnets attached to the back surface of the track, in which the grooved front surface receives the sliding mechanisms, and in which the sliding devices, upon placement within the grooved front surface, slide along the length of the track.

### BACKGROUND

Welding is a technology that has been around for centuries with the first recorded uses dating to the Bronze and Iron Ages in Europe and the Middle East. It is the process of joining metal objects, by heating them past their melting temperatures, thereby forming a molten pool. As the pool cools and solidifies it creates a strong bond of the two objects.

While welding is a useful process to join various materials, many dangerous byproducts result from welding. For example, to obtain a molten state in which a material is joined to another piece of material, it is heated to a temperature greater than its melting point. The melting point of most metals is very high. Heating the metal to these temperatures requires a significant heat source, which is supplied in many forms including, but not limited to, gas flames, electric arcs, and lasers. These sources expose the welder to not only high temperatures, but also to these dangerous heat sources. Often times, these heat sources output various toxic gases and particulate matter. The particulate matter is often superheated, and poses a significant danger to welders. Additionally, the molten metal produces very bright light rays. The ultraviolet light emanating from the molten metal causes damage to the retina and cornea of the eye.

Due to the dangerous nature of welding, welders wear protective clothing as a barrier against the dangerous byproducts of welding. However, bystanders near the welder's workspace are exposed to the same byproducts of welding as welders. These bystanders are often without the advantage of a welder's protective clothing. Moreover, the dangers of welding also pose a threat to the surrounding environment. For example, superheated particulate matter could damage nearby equipment or even spark a fire.

### BRIEF DESCRIPTION OF THE DRAWINGS

The accompanying drawings illustrate various examples of the principles described herein and are a part of the specification. The illustrated examples, however, do not limit the scope of the claims.

FIG. 1 is a front view of a welding curtain, according to an example of the principles described herein.

FIG. 2 is a front view of a welding curtain, according to another example of the principles described herein.

FIG. 3a is a front view of a welding curtain, according to still another example of the principles described herein.

FIG. 3b is a top view of the welding curtain of FIG. 3a, according to an example of the principles described herein.

FIG. 4 is a perspective view of a welding curtain, according to yet another example of the principles described herein.

FIG. 5 is a side view of a welding curtain, according to yet another example of the principles described herein.

Throughout the drawings, identical reference numbers designate similar, but not necessarily identical, elements.

### DETAILED DESCRIPTION

Welding curtains are an example of a protective measure that reduces the global exposure to the harmful effects of welding. However, such widespread protection is made more difficult as a welder's task often requires onsite welding of complex workpieces in complex workspaces where a welding curtain is difficult to use. Thus, it would be advantageous to construct a welding curtain that could form to the shape of the workspace and attach to a workpiece directly.

Welding has long been a staple to any growing infrastructure and its importance will grow as nations continue to develop. This increased importance and a heightened awareness of the dangers of welding justify an increased focus on public protection. While welding curtains provide a feasible manner to reduce injuries and environmental impact, certain inefficiencies still impede their use. For example, the shape and size limitations that accompany many welding projects inhibit the use of a welding curtain. For example, a welder working on the undercarriage of a tractor-trailer may not be able to position a framed welding curtain to adequately shield the welding area.

In light of this and other issues, the present specification discloses a self-supporting welding curtain by comprising a number of magnets coupled to a sheet of material. In this example the sheet of material may be constructed of a flexible fire-resistant material that drapes around the welding area and protects bystanders from the harmful byproducts of welding, i.e. lasers, gas flames, electric arcs, ultraviolet radiation, toxic gases, and particulate matter. This sheet also protects the surrounding environment from those same harmful byproducts, fumes, and particulate matter. In this example, the magnets, which are coupled to the flexible fire-resistant sheet of material, are attached to a ferromagnetic mounting surface located near the welding site to partition-off the welding workspace. In one example, the ferromagnetic mounting surface is the workpiece to which material is to be welded. By using a number of magnets along a surface of a flexible fire-resistant material, the curtain can be shaped to conform to irregularly defined workpieces, fit in irregularly defined workspaces, and can be draped to cover the welding site. Returning to the same example of a welder welding the undercarriage of a tractor-trailer, the welding curtain could be magnetically attached to the undercarriage of the tractor-trailer to shield the welding workspace.

In the following description, for purposes of explanation, numerous specific details are set forth in order to provide a thorough understanding of the present systems and methods. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

Throughout this specification and in the appended claims, the term “a number of or similar language is meant to be understood broadly as any positive number comprising 1 to infinity; zero not being a number, but the absence of a number.

Additionally, throughout this specification and in the appended claims, the term “fire-resistant material” is meant to be understood broadly as a number of materials or a number of layers of a number of materials, having any degree of transparency that is designed to resist burning and withstand heat.

As used in the present specification and in the appended claims, the term “magnet” is meant to be understood broadly as any material that produces a magnetic field. Some examples of magnets include, but are not limited to, a permanent magnet, ferromagnetic materials, an electromagnet, a ferrite magnet, a ceramic magnet, magnets formed from rare earth elements such as, for example, neodymium, and combinations thereof.

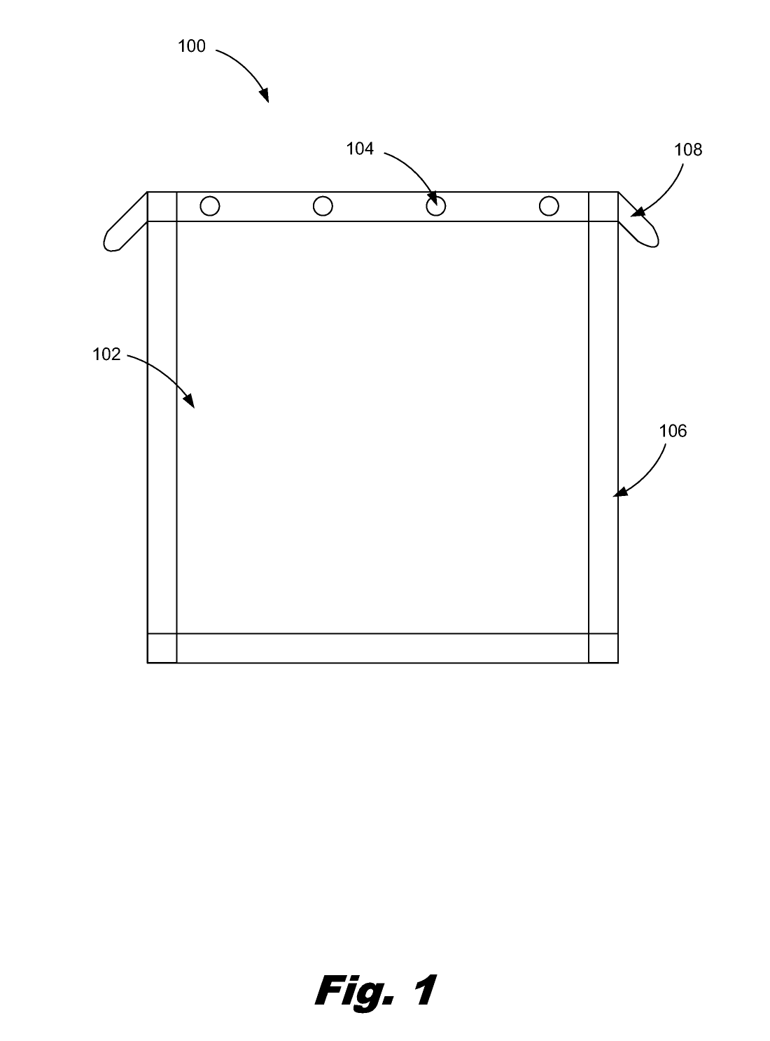

Referring now to the figures, FIG. 1 shows a front view of a welding curtain (100). According to an example, the welding curtain (100) includes a number of sheets of material (102) made of a flexible fire-resistant material. The flexible fire-resistant material is designed to resist any resultant flames, and withstand the extreme heat created by a welding process. The sheet of material (102) also shields bystanders and the environment from the fumes and hot particulate matter. The flexibility of the sheet of material (102) allows the curtain to align to the space and size constraints of a given workspace and workpiece. Additionally, the sheet of material (102) protects bystanders' eyes from the bright molten pool and electric arcs that are other byproducts of welding.

Examples of such material may include, but are not limited to, an aromatic polyamide (aramid) such as a meta-aramid or a para-aramid, polybenzimidazole (PBI) (poly [2,2′-(m-phenylen)-5,5′ bibenzimidazol] with a chemical formula of C₂₀N₄H₁₂)ₙ), asbestos, leather, polyvinyl chloride (PVC), materials coated with a fire resistant coating, and combinations thereof. An example of a meta-aramid is a product sold by DuPont™ under the tradename Nomex®. Nomex® is a polymer produced by condensation reaction from the monomers m-phenylenediamine and isophthaloyl chloride. The resultant fibers may be formed into a sheet. An example of a para-aramid is poly paraphenylene terephthalamide, and is a product sold by DuPont™ under the tradename Kevlar®. Kevlar® is synthesized in solution from the monomers 1,4-phenylene-diamine (para-phenylenediamine) and terephthaloyl chloride in a condensation reaction where the result has liquid-crystalline behavior, and in which mechanical drawing orients the polymer chains in the fiber's direction.

Examples of materials coated with a fire-resistant coating, include, for example, coated textiles. One example of such a material is a textile coated with a chemical product sold by Buckeye Fabric Finishers, Inc.™ under the tradename Pyrosnuff®. Materials other than textiles may also be coated with a fire-resistant coating.

While FIG. 1 depicts the sheet of material (100) as a square, it may be constructed in any shape and size. In one example, the sheet of material (102) is transparent. A transparent sheet of material (102) allows observers to watch the welding process while still being protected from its harmful effects. In another example, the sheet of material (102) is opaque.

The welding curtain (100) includes a number of magnets (104) coupled to a portion of the sheet of material (102). The sheet of material (102) is attached to a ferromagnetic mounting surface via these magnets (104). In this manner, the welding workspace is partitioned. In one example, the magnets may be placed on non-linear surfaces of a particular workpiece and can therefore conform to any dimensions of the welding workpiece. While FIG. 1 depicts four magnets circular in shape, a number of magnets of any shape and size may be used.

In one example, the magnets (104) use an electric current to generate a magnetic field; such magnets are referred to as electromagnets. In this example, the magnets (104) may be placed on a ferromagnetic mounting surface and a power source may be initiated to supply an electric current to a wire coil surrounding a metallic core. Doing so creates a magnet that will adhere to the ferromagnetic mounting surface. Stopping of the electric current will disengage the electromagnets from the workpiece, and, thus, release the welding curtain (100) from the workpiece.

In another example, the magnet (104) is a ferromagnetic material that produces a magnetic field without influence from an outside source. For example, the magnet (104) in this example is a permanent magnet or a ferrite magnet. In this example, the magnet (104) attaches to the workpiece via this self-producing magnetic field. The magnetic field produced by the magnet (104) is overcome by applying a force opposite to the magnetic field. Thus, a user overcomes this magnetic field and removes the welding curtain (100) from the workpiece by pulling the magnets away from the workpiece.

The magnets (104) may be coupled to the sheet of material (102) using a number of mechanical fastening devices. Such fasteners include, but are not limited to nuts and bolts, screws, rivets, and adhesives, among others. In certain examples, an edge of the sheet of material (102) is folded onto the main body of the sheet of material (102) and sewn along its length, creating a sleeve along an edge of the sheet of material (102). The magnets (104) may then be placed in this sleeve as desired. In this example, the magnets (104) may be fixed in position by additional seams sewn on either side of the magnets (104). In another example, these seams may be spaced such that the magnets (104) are permitted to move within the sleeve. In this example, the magnets (104) may be positioned according to the dimensions of the workpiece.

According to certain examples, the welding curtain (100) may also include a reinforcement material (106) coupled to at least a portion of the sheet of material (102). This reinforcement material (106) may be constructed out of a number of materials including, but not limited to nylon webbing, plastic, and rubber. In one example, the reinforcement material (106) is coupled to a portion of the welding curtain (100) at which the magnets (104) are coupled. In this example, the reinforcement material (106) provides added strength to the interface between the welding curtain (100) and magnets (104), and decreases wear and tear that may occur along this interface due to repeated engagement and disengagement of the welding curtain (100) from a workpiece.

Further, the reinforcement material (106) may be place along a number of edges of the welding curtain (100). In this example, as the welding curtain (100) is moved from a welding site to a storage site, the reinforcement material (106) protects the edges of the welding curtain (100) from general wear and tear. Additionally, when the welding curtain (100) is used in circumstances where a portion of the sheet of material (102) is in contact with the ground, the reinforcement material (106) protects the sheet of material (102) from any wear that may result from such use. The reinforcement material (106) may be attached to the sheet of material (102) using a variety of mechanical fastening devices. These devices include, but are not limited to, nuts and bolts, screws, rivets, and adhesives. The reinforcement material (106) may also be sewn or glued to the sheet of material (102).

The welding curtain (100) may further include a number of handles (108) located along a number of edges of the sheet of material (102). While FIG. 1 depicts two handles (108) located at joining edges of the sheet of material (102) a number of handles may be located at any point along the sheet of material (102). The handles (108) may be used to position the welding curtain (100). The handles (108) also reduce the stress on the sheet of material (102) as it is removed from the ferromagnetic mounting surface and the magnetic field of the magnets (104) are overcome by force. In addition to reducing stress on the sheet of material (102), the handles (108) also assist in the attachment and removal of the welding curtain (100) from the ferromagnetic mounting surface or workpiece.

In one example, the handles (108) are made of a strong flexible material such as nylon or polyvinyl chloride. In this example, the handles (108) are formed by folding a strip of the strong flexible material and fastening it to itself by nuts and bolts, screws, rivets, and adhesives. The handles (108) may also be sewn or glued to the sheet of material (102). This creates a loop that may be attached to the sheet of material (102). In another example, the handle (108) may comprise a plastic-molded or metal handle that is coupled to the sheet of material (102).

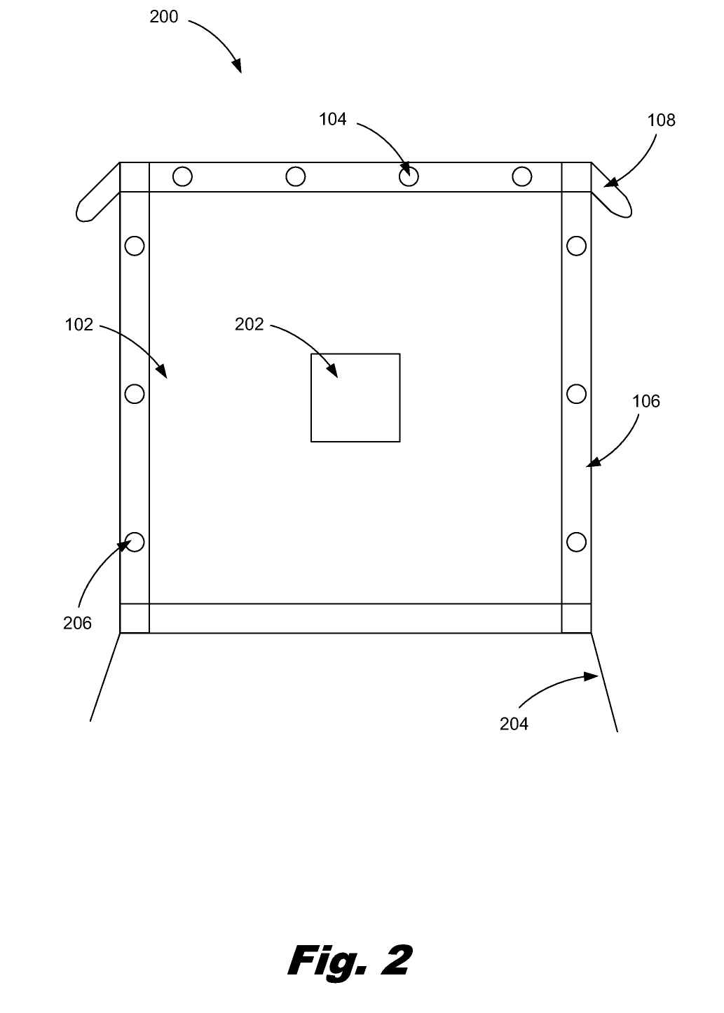

FIG. 2 is a front view of a welding curtain (200), according to another example of the principles described herein. The welding curtain (200) may include the sheet of material (102), magnets (104), reinforcement material (106), and handles (108) as described above. In the example of FIG. 2, the welding curtain (200) includes a viewing window (202) located within a portion of the sheet of material (102). Through the viewing window (202), a bystander may observe the activity within the welding workspace. In this example, the viewing window (202) is made of a flexible fire-resistant material. The flexible fire-resistant material may be transparent. Examples of such transparent material include, but are not limited to, polyvinyl chloride (PVC). The viewing window (202) may be coupled to the sheet of material (102) using a number of mechanical fastening devices. Such devices include, but are not limited to, nuts and bolts, screws, rivets, and adhesives. In another example, the viewing window (202) may be sewn to the sheet of material (102).

The welding curtain (200) may also include anchors (204) attached to at least one edge of the sheet of material (102). These anchors (204) brace the welding curtain (200) while in use. In this example, the anchors (204) include cord fasteners extending from a portion of the sheet of material (102). The free end of the anchors (204) are fastened to a stable location, such as the ground. While FIG. 2 depicts two anchors (204) a number of anchors may be used to secure the welding curtain (200). In one example, the anchors (204) can be placed a distance away from the workpiece such that the welding curtain (200) hangs at an angle. This increases the area of the welding workspace available for a welder to work.

In one example, the anchors (204) may include weights attached to at least one edge of the sheet of material (102). These weights may be attached directly to the sheet of material (102) by any of the mechanical fastening devices described above including, but not limited to, nuts and bolts, screws, rivets, adhesive, or by being sewn onto the sheet material (102) or into a sleeve along an edge of the sheet of material (102). In this example, the force of gravity on the weights provides the anchoring support. In another example, the anchors may be attached indirectly to the sheet of material (102) through a cord fastener such as that depicted in FIG. 2. In this example, the weight suspendeds from or is placed on a surface to secure the welding curtain (200).

One example of the welding curtain (200) may include a number of joining devices (206) located along a number of edges of the sheet of material (102). The joining devices (206) allow multiple welding curtains (200) to be coupled to one another to cover greater welding workspaces. In one example, the joining devices (206) may include a number of magnets coupled to the sheet of material (102) using a number of mechanical fastening devices including, but not limited to nuts and bolts, screws, rivets, adhesives, or by being sewn into a sleeve of the sheet of material (102). In this example, multiple welding curtains (200) may be positioned adjacent to one another such that the magnets in corresponding sheets of material (102) align and connect to one another. In other examples, the joining devices (206) include a number of mechanical fastening devices that can be repeatedly engaged to and disengaged from on another. Examples of these fasteners include, but are not limited to hook-and-loop fasteners, grommets and hooks, buttons, snaps, and zippers, among others.

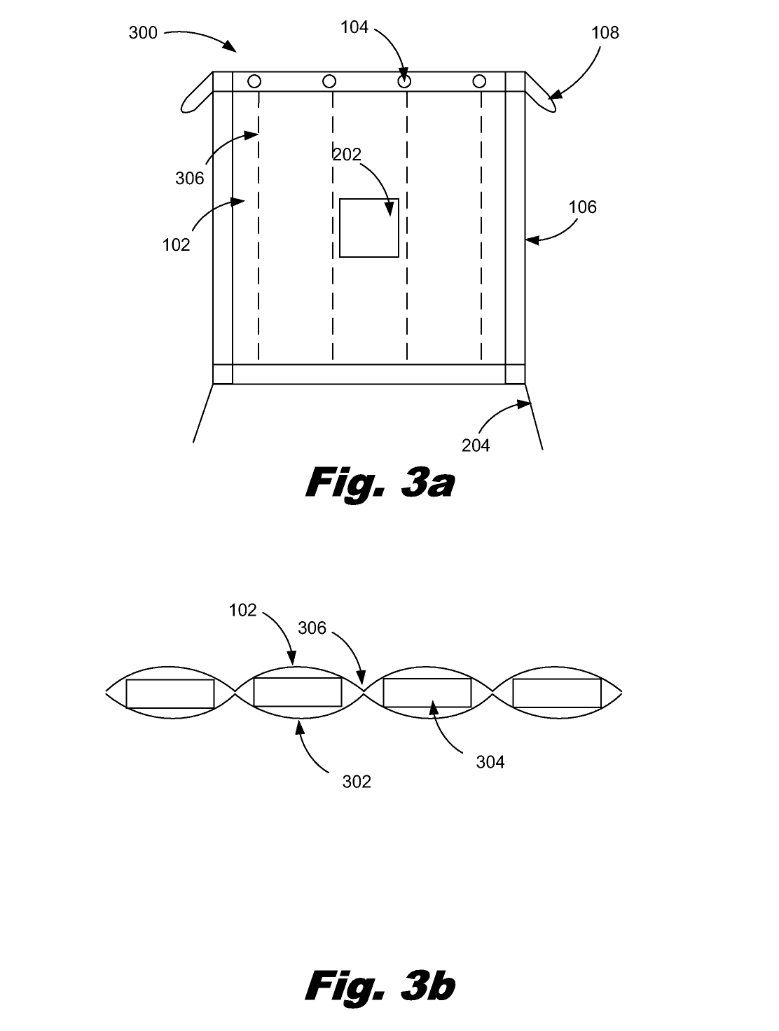

FIGS. 3a and 3b depict a front view and top view, respectively, of a welding curtain (300) according to still another example of the principles described herein. The welding curtain (300) may include the sheet of material (102), magnets (104), reinforcement material (106), handles (108), viewing window (202), anchors (204) and joining devices (206) as described above. The welding curtain (300) may also include a backing sheet (302) coupled to the edges of the sheet of material (102). In one example, the backing sheet (302) is formed by folding the sheet of material (102) and joining it along corresponding edges.

The welding curtain (300) may further include a number of dividers (304) placed between the backing sheet (302) and the sheet of material (102) to provide for folding of the welding curtain (300). In this example, the dividers (304) are fixed in position by seams sewn on either side of the dividers (304). While FIG. 3 depicts five dividers placed longitudinally between the backing sheet (302) and the sheet of material (102), the dividers (304) may be any size and shape. For example, the dividers (304) may include square panels, kept in position with seams. When not in use the welding curtain (300) is folded along these dividers (304) for easy storage.

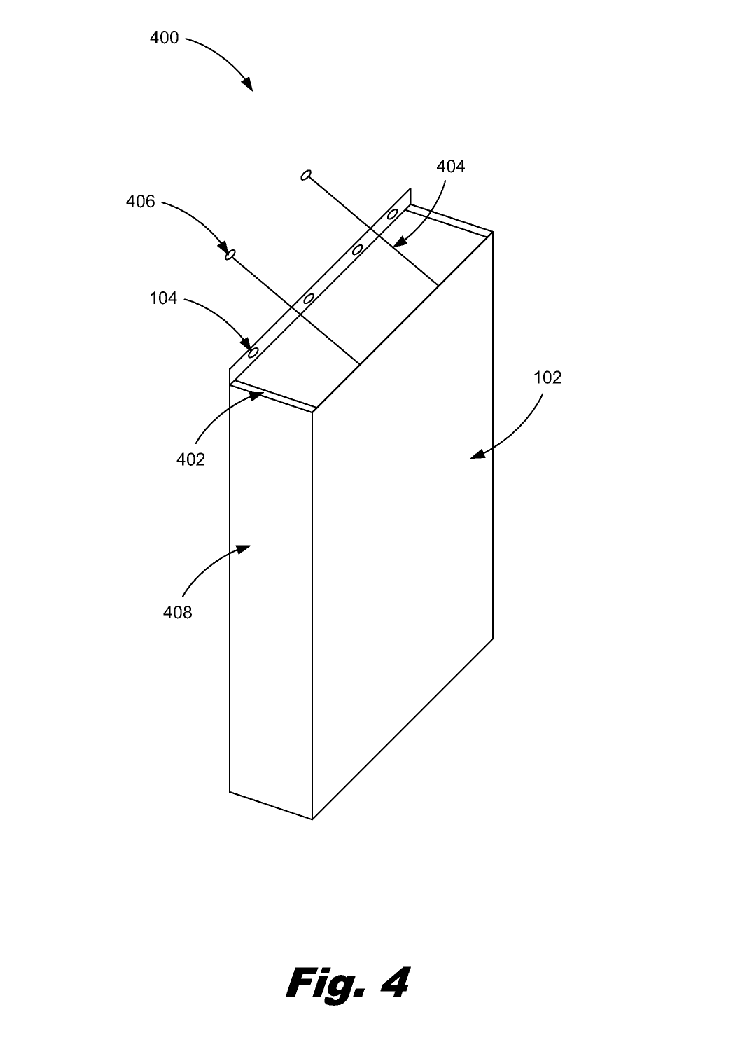

FIG. 4 is a perspective view of a welding curtain (400), according to yet another example of the principles described herein. The welding curtain (400) may include the sheet of material (102), and magnets (104) as described above. In the example of FIG. 4, the welding curtain (400) includes a number of approximately horizontal support arms (402). One end of the horizontal support arms (402) is located at the edge of the sheet of material (102) in which the magnets (104) are located. The horizontal support arms (402) run perpendicular to this same edge. In one example, the horizontal support arms (402) are attached to at least a portion of the sheet of material (102) via a number of mechanical fastening devices including, but not limited to, nuts and bolts, screws, rivets, and adhesive, among others. In one example, a strip of a flexible fire-resistant material may be sewn longitudinally onto the surface of the sheet of material (102), thus creating a sleeve on the sheet of material (102) in which the horizontal support arms (402) may be placed as desired. In this example, the sheet of material (102) would extend from the ferromagnetic mounting surface outward along the length of the horizontal support arms (402) and then drape vertical at the end of the horizontal support arms (402). Thus, in this example, a welder is provided with a larger workspace to perform his or her welding processes on the workpiece.

In one example, the welding curtain (400) may include a number of angle supports (404) to buttress the welding curtain (400). In one example, the angle supports (404) are constructed of flexible cord fasteners extending from a portion of the sheet of material (102). In this example, the end of the angle support (404) that is not attached to a portion of the sheet of material (102) may include a magnet (406) that may be attached to the ferromagnetic mounting surface or workpiece. The angle supports (404) in this example elevate a portion of the sheet of material (102) to increase the area of the welding workspace in which the welder may weld. In another example, the angle supports (404) are rigid members. In this example, one end of the angle supports (404) may be rotatably coupled to the horizontal support arms (402).

According to the example of FIG. 4, the welding curtain (400) may include a number of wall sheets (408) joined along at least one edge of the sheet of material (102). The wall sheets (408) further enclose the welding workspace and further protect the bystanders and the environment against the dangerous byproducts of welding. In this example, the wall sheets (408) may be constructed of a flexible fire-resistant material. In one example, the wall sheets (408) are permanently fixed to a number of edges of the sheet of material (102) using any mechanical fastening devices which include, but are not limited to, nuts and bolts, screws, rivets, and adhesives, among others. In another example, the edges of the wall sheet (408) and the edge of the sheet of material (102) may be sewn together. In yet another example, the wall sheets (408) may be attached to the sheet of material (102) by a number of mechanical fastening devices that can be repeatedly engaged to and disengaged from on another. Examples include, but are not limited to hook-and-loop fasteners, grommets and hooks, buttons, snaps, magnets, and zippers, among others.

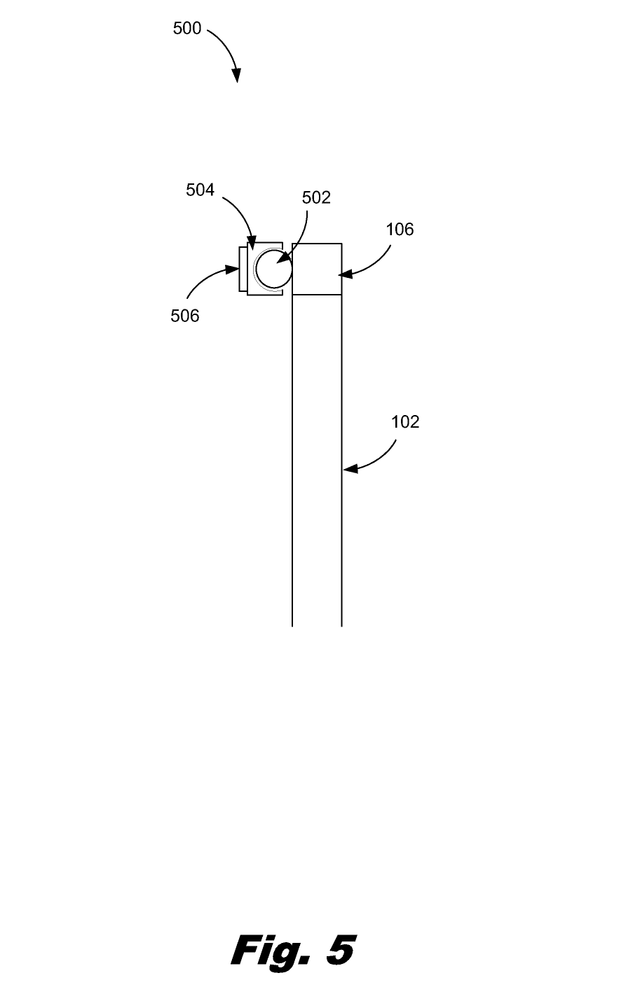

FIG. 5 is a side view of a welding curtain (500), according to yet another example of the principles described herein. The welding curtain (500) may include the sheet of material (102), and reinforcement material (106) as described above. In one example, the welding curtain (500) may further include a number of sliding mechanisms (502) attached to at least a portion of an edge of the sheet of material (102). The sliding mechanisms (502) may be attached to the sheet of material (102) using any mechanical fastening devices which include, but are not limited to, nuts and bolts, screws, rivets, adhesives, and by being sewn to the sheet of material (102).

The example of FIG. 5 further includes a track (504) with a grooved front surface defined therein, and a back surface. The grooved front surface of the track (504) receives the sliding mechanisms (502) of the welding curtain (500). In this example, the back surface of the track (504) includes a number of magnets (506) that are attached to the ferromagnetic mounting surface or workpiece. The track (504) and sliding mechanisms (502) allow the welding curtain (500) to be moved along the track.

In one example, the track (504) of the welding curtain (500) is made of a plastic material. The plastic material can be shaped to conform to any irregularly-defined workpieces, and the sheet of material (102) can be draped to cover the welding site.

The preceding description has been presented to illustrate and describe examples of the principles described. This description is not intended to be exhaustive or to limit these principles to any precise form disclosed. Many modifications and variations are possible in light of the above teaching.

What is claimed is:

1. A welding curtain, comprising:
a substrate comprising a fire-resistant material; and
a number of magnets coupled to a portion of the substrate.

2. The welding curtain of claim 1, in which the fire-resistance material is flexible.

3. The welding curtain of claim 1, in which the substrate comprises a number of layers of material, and in which the layers of material comprise an aromatic polyamide, a meta-aramid, a para-aramid, polybenzimidazole (PBI), asbestos, leather, polyvinyl chloride (PVC), chemically coated materials, and combinations thereof.

4. The welding curtain of claim 1, in which the substrate is opaque.

5. The welding curtain of claim 4, further comprising a viewing window located within a portion of the substrate,
in which the viewing window comprises a transparent material.

6. The welding curtain of claim 4, in which the transparent material is a flexible, fire-resistant material.

7. The welding curtain of claim 1, in which the substrate is transparent.

8. The welding curtain of claim 1, further comprising:
a backing sheet coupled to the substrate; and
a number of rigid dividers placed between the backing sheet and substrate.

9. The welding curtain of claim 1, further comprising a reinforcement material coupled to at least a portion of the edges of the substrate.

10. The welding curtain of claim 1, further comprising a number of handles located along a number of edges of the substrate.

11. The welding curtain of claim 1, further comprising:
a number of approximately horizontal support arms attached to a portion of the substrate comprising a first end and a second end,
in which the first end of the horizontal support arms are coupled to the portion of the substrate at which the magnets are coupled.

12. The welding curtain of claim 1, further comprising a number of angled supports comprising a first end and a second end,
in which a magnet is attached to the first end of the angled supports, and
in which the second end of the angled supports are coupled to the substrate.

13. The welding curtain of claim 1, further comprising a number of wall sheets joined along at least one edge to the substrate.

14. The welding curtain of claim 1, further comprising a number of anchors attached to at least one edge of the substrate;
in which the anchors are fixed to a stable location.

15. The welding curtain of claim 1, further comprising a first joining device coupled to at least one edge of the substrate;
in which the first joining device receives a second joining device of a second welding curtain.

16. A welding curtain, comprising:
a substrate;
a number of sliding mechanisms attached to at least a portion of an edge of the substrate;
a track defining a groove within a front surface and comprising a back surface; and
a number of magnets attached to the back surface of the track;
in which the grooved front surface receives the sliding mechanisms; and
in which the sliding devices, upon placement within the grooved front surface, slide along the length of the track.

17. The welding curtain of claim 16, in which the substrate comprises an aromatic polyamide, a meta-aramid, a para-aramid, polybenzimidazole (PBI), asbestos, leather, polyvinyl chloride (PVC), chemically coated materials, and combinations thereof.

18. The welding curtain of claim 16, further comprising a reinforcement material coupled to at least a portion of the edges of the substrate.

19. The welding curtain of claim 16, further comprising:
a number of handles located along a number of edges of the substrate.

20. A method of making a welding curtain comprising:
aligning a number of magnets to at least one edge of a fire-resistant substrate; and
coupling the magnets to the substrate.
